(19) United States
(12) Patent Application Publication
(10) Pub. No.: US 2026/0001450 A1
(43) Pub. Date: Jan. 1, 2026

(54) VEHICLE CONTROL DEVICE

(71) Applicant: HONDA MOTOR CO., LTD., Tokyo (JP)

(72) Inventors: Akira Sakata, Tokyo (JP); Koji Hashimoto, , Tokyo (JP); Shogo Usui, Tokyo (JP); Kazunari Ochi, Tokyo (JP); Mizuki Katsu, Tokyo (JP); Taiji Okawa, Tokyo (JP); Ryo Iguchi, Tokyo (JP)

(21) Appl. No.: 19/198,198

(22) Filed: May 5, 2025

(30) Foreign Application Priority Data
Jun. 28, 2024 (JP) 2024-104667

(51) Int. Cl. B60N 2/02; B60N 2/06

(52) U.S. Cl. CPC B60N 2/02253; B60N 2/0268; B60N 2/06

(57) ABSTRACT

In a second power source control mode, after an entry/exit recognition unit recognizes that a user has exited a vehicle, when a driver's seat door sensor detects two or more times that the driver's seat door has been changed from an open state to a closed state and it is recognized that the user is in the vehicle, an entry/exit support control unit controls the positional relationship between a steering column and a driver's seat in a driver's seat area to be a returned positional relationship.

### INCORPORATION BY REFERENCE

The present application claims priority under 35 U.S.C. § 119 to Japanese Patent Application No. 2024-104667 filed on Jun. 28, 2024. The content of the application is incorporated herein by reference in its entirety.

### BACKGROUND OF THE INVENTION

### Field of the Invention

The present invention relates to a vehicle control device.

### Description of the Related Art

In recent years, there have been increasing efforts to provide access to a sustainable transportation system that takes into consideration people in vulnerable positions, such as the elderly, people with disabilities, and children, among traffic participants. In order to realize this, attention is given to research and development for further improving traffic safety and convenience through development relating to the ease of entering and exiting vehicles.

Conventionally, there is known a technology that automatically retracts a driver's seat when a user exits a vehicle, thereby increasing the space for the user to exit the vehicle, and also increasing the space for the next time the user enters the vehicle. According to this kind of technology, after entering the vehicle, the user operates an operator (ignition key, push starter, etc.) to automatically move the retracted seat forward to a driving position (see, for example, Japanese Unexamined Patent Application Publication No. 2012-020601).

By the way, in a case when a driver retracts the driver's seat and exits the vehicle with the vehicle's driving power source being kept in an on state, for an errand for a short time, if the driver's seat is moved forward to the driving position in response to the operation of the operator for switching the driving power source such as an ignition switch between on and off as in the above-described related art, the driver will face the following problem. In other words, even though the driver exited the vehicle with the driving power source being kept in the on state, when the driver returns to the vehicle, the driver must inconveniently operate the operator for switching the driving power source between on and off to turn off the driving power source once and then turn on the driving power source again to move the driver's seat forward to the driving position.

In order to solve the above problem, the purpose of the present application is to improve the ease of entry and exit by automatically returning the positional relationship between a steering column and the driver's seat to a positional relationship suitable for driving, without depending on the driver to operate the operator when the driver, who exited the vehicle with the driving power source of the vehicle being kept in the on state, returns and enters the vehicle. This would ultimately contribute to the development of a sustainable transportation system.

### SUMMARY OF THE INVENTION

In order to achieve the purpose, one aspect of the present invention is a vehicle control device for controlling activation of a vehicle having a driver's seat area drive unit that changes the positional relationship between a steering column and a driver's seat in a driver's seat area, and a driver's seat door sensor that detects open and closed states of a driver's seat door, the vehicle control device including: an entry/exit recognition unit that recognizes that a user of the vehicle has entered or exited the vehicle; a power source control unit that switches between a first power source control mode and a second power source control mode, wherein, in the first power source control mode, the power source control unit switches supply from a driving power source of the vehicle to an off state in response to a selection operation of the user when an exit completion determination condition in which the entry/exit recognition unit recognizes that user has exited the vehicle and the driver's seat door sensor detects that the driver's seat door has been changed from an open state to a closed state is satisfied, and, in the second power source control mode, the power source control unit keeps the supply from the driving power source in an on state even after the exit completion determination condition is satisfied; and an entry/exit support control unit that causes the driver's seat area drive unit to switch the positional relationship between the steering column and the driver's seat in the driver's seat area, between a first positional relationship suitable for driving and a second positional relationship suitable for entering and exiting the vehicle, wherein, when the driver's seat door sensor detects that the driver's seat door has been changed from the closed state to the open state while the vehicle is in a parked state, the entry/exit support control unit changes the positional relationship to the second positional relationship by moving at least one of the steering column and the driver's seat in the driver's seat area, and, in the second power source control mode, after the entry/exit recognition unit recognizes that the user has exited the vehicle, when the driver's seat door sensor detects two or more times that the driver's seat door has been changed from the open state to the closed state and it is recognized that the user is in the vehicle, the entry/exit support control unit controls the positional relationship between the steering column and the driver's seat in the driver's seat area to be the first positional relationship.

According to the aspect of the present invention, when the driver, who has exited the vehicle with the driving power source of the vehicle being kept in the on state, returns and enters the vehicle, the positional relationship between the steering column and the driver's seat is automatically returned to the positional relationship suitable for driving, without depending on the driver to operate an operator, thereby improving the ease of entry and exit.

### BRIEF DESCRIPTION OF THE DRAWINGS

FIG. 1 is a schematic diagram showing a configuration around a driver's seat area;

FIG. 2 is a block diagram showing a configuration of a main control system provided in a vehicle; and

FIG. 3 is a flowchart showing an operation of a control device provided in the vehicle.

### DETAILED DESCRIPTION OF THE INVENTION

### Embodiment

Hereinafter, an embodiment of the present invention will be described with reference to the drawings.

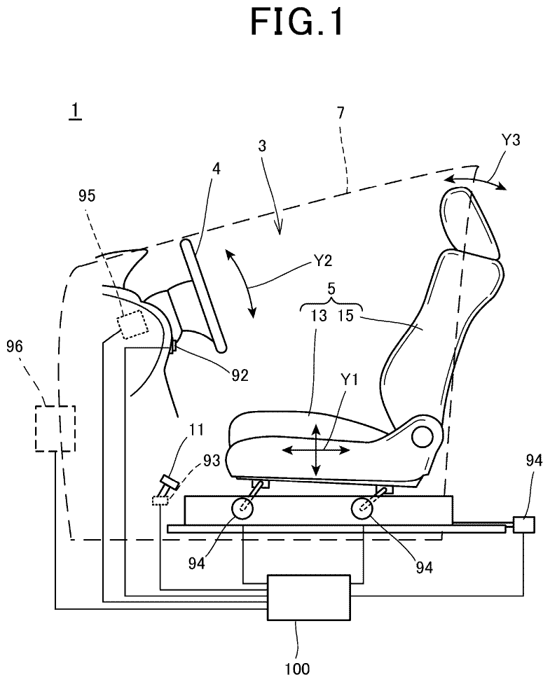

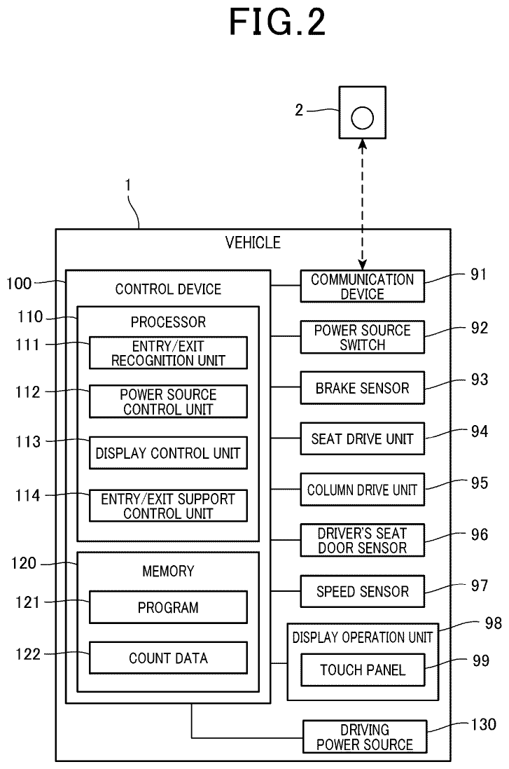

FIG. 1 is a schematic diagram showing a configuration around a driver's seat area 3. FIG. 2 is a block diagram showing a configuration of a main control system provided in a vehicle 1.

The vehicle 1 may be a vehicle using an internal combustion engine as a drive source, an electric vehicle using a motor as a drive source, or a hybrid vehicle using an internal combustion engine and a motor. In the present embodiment, the vehicle 1 that is a four-wheeled automobile will be described as an example.

The vehicle 1 includes a driver's seat 5, and a steering column 4 forward of the driver's seat 5 in the driver's seat area 3 where a driver as a user who drives the vehicle 1 enters and exits. The driver's seat area 3 is an area which is used by the driver, and in which the driver's seat 5 where the driver sits and the steering column 4 to be operated by the driver are disposed.

The vehicle 1 has a driver's seat door 7 on the driver's seat area 3 side. The driver's seat 5 is an example of a driver's seat of the present disclosure.

The vehicle 1 includes a brake pedal 11 forward and downward of the driver's seat 5. The vehicle 1 has a display operation unit 98 (described later) forward of the driver's seat 5 and adjacent to the steering column 4.

The driver's seat 5 includes a seat cushion 13 on which the driver sits, and a seat back 15 functioning as a backrest.

A seat drive unit 94 (actuator) that moves the position of the driver's seat 5 is connected to a lower part of the seat cushion 13. The seat drive unit 94 moves the position of the driver's seat 5 in the front-rear direction and the up-down direction as shown by arrow Y1.

The steering column 4 has a tilt mechanism and is connected to a column drive unit 95 (actuator) that changes the position of the steering column 4 in a substantially arc shape as shown by arrow Y2 for the steering column 4. The column drive unit 95 is configured as a drive unit for moving the steering column 4 in a so-called tilting manner, but is not limited to this and may be configured as a drive unit for extending and shortening the steering column 4 having a telescopic mechanism, or may be configured as a drive unit for changing the position of the steering column 4 having a tilt mechanism and a telescopic function.

The seat drive unit 94 and the column drive unit 95 are examples of driver's seat area drive units of the present disclosure.

A control device 100 of the vehicle 1 includes a processor 110 such as a central processing unit (CPU) or a micro-processor unit (MPU), a memory 120, and an interface circuit to which other devices and sensors are connected. The control device 100 is a so-called electronic control unit (ECU). The control device 100 is an example of a vehicle control device of the present disclosure.

A communication device 91, a power source switch 92, a brake sensor 93, the seat drive unit 94, the column drive unit 95, a driver's seat door sensor 96, a speed sensor 97, and the display operation unit 98 are connected to the control device 100. Further, a driving power source 130 is connected to the control device 100. The driving power source 130 is a battery mounted on the vehicle 1. Each electric drive unit in the vehicle 1 is supplied with power by the driving power source 130.

The memory 120 is a memory for storing a program and data. The memory 120 stores a program 121, count data 122 (described later), and data to be processed by the processor 110. The memory 120 has a non-volatile storage area. Moreover, the memory 120 may include a volatile storage area to form a work area for the processor 110. The memory 120 is constituted by, for example, read-only memory (ROM) or random access memory (RAM).

The communication device 91 is a communication device having a transmitter and a receiver, and executes near-field communication to communicate with an electronic key 2 that is used mainly by the driver among users of the vehicle 1. Examples of the electronic key 2 include a smart key, a key fob, a smartphone, a smartwatch, and facial recognition.

The power source switch 92 is a physical button that can switch between an on state and an off state of the supply from the driving power source 130 by being operated.

The brake sensor 93 is a sensor that detects when the brake pedal 11 is operated.

The driver's seat door sensor 96 is a sensor that detects whether the driver's seat door 7 is in an open state or a closed state.

The speed sensor 97 is a sensor that detects the speed of the vehicle 1.

The display operation unit 98 includes a touch panel 99. The touch panel 99 displays screens, and operation buttons as software buttons.

The processor 110 functions as an entry/exit recognition unit 111, a power source control unit 112, a display control unit 113, and an entry/exit support control unit 114 by reading and executing the program 121 stored in the memory 120.

The entry/exit recognition unit 111 communicates with the electronic key 2 through the communication device 91. The entry/exit recognition unit 111 recognizes, based on the communication status between the communication device 91 and the electronic key 2, whether the electronic key 2 is located outside or inside the vehicle 1, and thereby recognizes that the user has entered the vehicle 1 and exited the vehicle 1.

The power source control unit 112 controls the supply of power from the driving power source 130 to switch between a first power source control mode and a second power source control mode in response to an operation of the user on the touch panel 99.

First, the configuration of the power source control unit 112 about the first power source control mode will be described.

In the first power source control mode, when an exit completion determination condition in which the entry/exit recognition unit 111 recognizes that the driver has exited the vehicle 1 and the driver's seat door sensor 96 detects that the driver's seat door 7 has been changed from the open state to the closed state is satisfied, the power source control unit 112 switches the supply from the driving power source 130 of the vehicle 1 to the off state. In the first power source control mode, after switching the supply from the driving power source 130 to the off state in response to satisfying the exit completion determination condition, when the entry/exit recognition unit 111 recognizes that the driver has entered the vehicle 1, the power source control unit 112 switches the supply from the driving power source 130 to the on state.

Next, the configuration of the power source control unit 112 about the second power source control mode will be described.

In the second power source control mode, even after the exit completion determination condition is satisfied, the power source control unit 112 keeps the supply from the driving power source 130 in the on state.

The display control unit 113 controls the display operation unit 98, receives an input from the display operation unit 98, and displays each screen through the touch panel 99.

When the vehicle 1 is in a parked state described later, the display control unit 113 displays a selection screen on which the second power source control mode is selectable. The display control unit 113 receives, from the user, an input for selecting the second power source control mode through a physical button on the display operation unit 98 or a software button on the touch panel 99. When the user does not select the second power source control mode, the display control unit 113 considers that the first power source control mode is selected.

The entry/exit support control unit 114 determines whether or not the vehicle 1 is in the parked state. The parked state is a state in which the shift position is in parking, and the vehicle 1 is at a speed of less than or equal to 2 kilometers per hour.

In accordance with a predetermined condition, the entry/exit support control unit 114 activates the seat drive unit 94 and the column drive unit 95 and moves at least one of the steering column 4 and the driver's seat 5 in the driver's seat area 3 to switch the positional relationship between the steering column 4 and the driver's seat 5, between a returned positional relationship suitable for driving and a retracted positional relationship corresponding to a positional relationship that makes it easier for the driver to enter and exit when getting in or out of the vehicle. The user can select which positional relationship to switch to when the driver enters and exits the vehicle by moving one or both of the steering column 4 and the driver's seat 5. The predetermined condition will be described in detail when explaining the operation of the control device 100 of the vehicle 1. Thus, when switching the positional relationship between the steering column 4 and the driver's seat 5, at least one of the steering column 4 and the driver's seat 5 is moved.

The returned positional relationship is an example of a first positional relationship in the present disclosure, and the retracted positional relationship is an example of a second positional relationship in the present disclosure.

The positional relationship between the driver's seat 5 and the steering column 4 in the returned positional relationship is adjusted to a position preferred by the driver according to an operation of the driver on a position change lever or the like.

Setting information for the returned positional relationship is stored in the memory 120 in advance in association with the electronic key 2. In the present embodiment, in the retracted positional relationship, the driver's seat 5 is moved backward to an arbitrary position (for example, 35 mm) from the position in the returned positional relationship, and the steering column 4 is at the uppermost position.

The present invention is not limited to this, and the seat back 15 may be configured to recline in the direction of arrow Y3 when moving from the position in the returned positional relationship ship to the position in the retracted positional relationship. Moreover, the settings of the seat drive unit 94 in the retracted positional relationship may be freely changed by the user, and the position of the seat cushion 13 in the up-down direction, the position of the seat cushion 13 in the front-rear direction, and the reclining position of the seat back 15 may be customizable. Such settings can be made through a display operation unit 98, or a display audio or a meter provided in the vehicle 1.

When the second power source control mode is selected and the supply from the driving power source 130 is kept in the on state while the vehicle is in the parked state, the entry/exit support control unit 114 counts the number of times the driver's seat door sensor 96 has detected a change of the driver's seat door 7 from the open state to the closed state using a counter variable CT. More specifically, the entry/exit support control unit 114 increments the counter variable CT by only one each time the driver's seat door 7 is changed to the closed state, and stores the incremented counter variable CT in the count data 122.

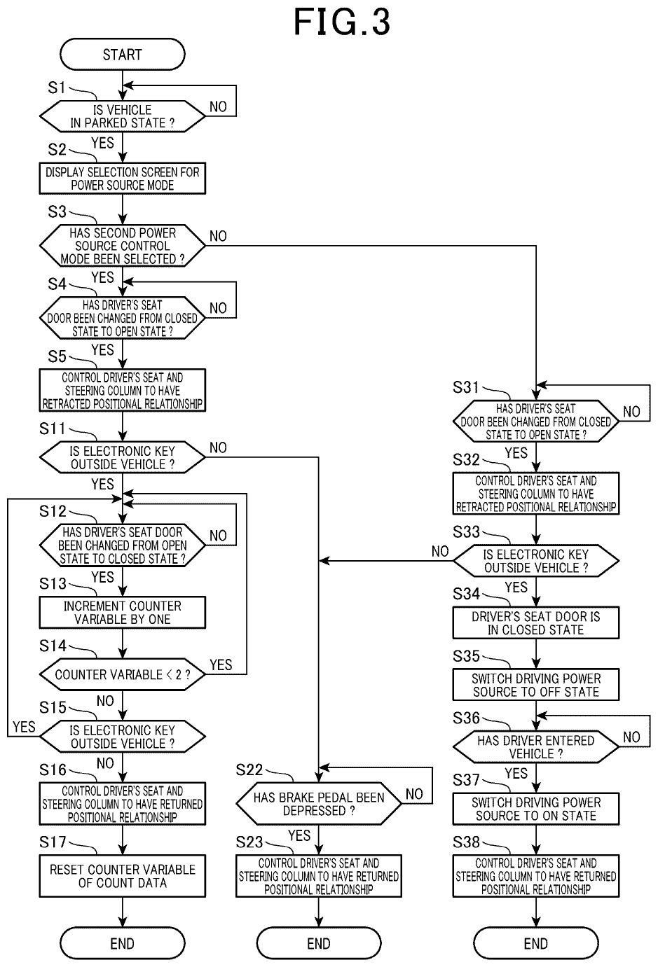

Next, an entry/exit support process that is executed by the control device 100 will be described according to the flowchart shown in FIG. 3.

First, the entry/exit support control unit 114 determines whether or not the vehicle 1 is in the parked state (step S1). If the vehicle 1 is not in the parked state (step S1: NO), the entry/exit support control unit 114 repeats the determination of step S1.

If the vehicle 1 is in the parked state (step S1: YES), then the display control unit 113 uses the touch panel 99 to display a selection screen for the user to select the first power source control mode and the second power source control mode (step S2). Next, the display control unit 113 determines whether or not the user has selected to switch the second power source control mode to the on state (step S3). If the second power source control mode has been selected (step S3: YES), the entry/exit support control unit 114 determines whether or not the driver's seat door 7 has been changed from the closed state to the open state (step S4). If the driver's seat door 7 has not been changed from the closed state to the open state (step S4: NO), the entry/exit support control unit 114 repeats the determination of step S4.

If the driver's seat door 7 has been changed from the closed state to the open state (step S4: YES), the entry/exit support control unit 114 operates the seat drive unit 94 and the column drive unit 95 to control the driver's seat 5 and the steering column 4 in the driver's seat area 3 to have the retracted positional relationship (step S5).

Next, the entry/exit recognition unit 111 determines whether or not the electronic key 2 is outside the vehicle while the supply from the driving power source 130 is kept in the on state (step S11). If the entry/exit recognition unit 111 determines that the electronic key 2 is outside the vehicle (step S11: YES), the entry/exit support control unit 114 determines whether the driver's seat door 7 has been changed from the open state to the closed state (step S12). If the driver's seat door 7 has not been changed from the open state to the closed state (step S12: NO), the entry/exit support control unit 114 repeats the determination of step S12.

If the driver's seat door 7 has been changed from the open state to the closed state (step S12: YES), the entry/exit support control unit 114 increments the counter variable CT only by one (step S13).

After step S13 is complete, the entry/exit support control unit 114 determines whether the counter variable CT is less than 2 (step S14), and proceeds to step S12 if the counter variable CT is less than 2 (step S14: YES).

If the entry/exit support control unit 114 determines that the counter variable CT is not less than 2 (step S14: NO), the entry/exit recognition unit 111 determines whether or not the electronic key 2 is outside the vehicle (step S15). If the entry/exit recognition unit 111 determines that the electronic key 2 is outside the vehicle (step S11: YES), the entry/exit support control unit 114 proceeds to step S12. If the entry/exit recognition unit 111 determines that the electronic key 2 is inside the vehicle (step S15: NO), the entry/exit support control unit 114 operates the seat drive unit 94 and the column drive unit 95 to control the driver's seat 5 and the steering column 4 in the driver's seat area 3 to have the returned positional relationship (step S16).

The operations up to step S16 correspond to, for example, the following cases. One case is that the driver selects the second power source control mode, exits the vehicle with the supply from the driving power source 130 being kept in the on state, changes the driver's seat door 7 to the closed state, and then the driver changes the driver's seat door 7 to the open state, enters the vehicle again, sits in the driver's seat 5 and closes the driver's seat door 7.

After step S16 is complete, the entry/exit support control unit 114 resets the counter variable CT of the count data 122 to zero (step S17). The second power source control mode is reset, and then the process is performed as if the first power source control mode is selected.

Thus, in the second power source control mode, after the entry/exit recognition unit 111 recognizes that the driver has exited the vehicle 1, when the driver's seat door sensor 96 detects two or more times that the driver's seat door 7 has been changed from the open state to the closed state and it is recognized that the user is in the vehicle 1, the entry/exit support control unit 114 controls the positional relationship between the driver's seat 5 and the steering column 4 in the driver's seat area 3 to be the returned positional relationship.

The above-described operation is particularly suitable for cases such as when the driver gets out of the vehicle only for a short time, particularly, for example, when the driver stops by a convenience store.

Returning to the explanation of step S11, if the entry/exit recognition unit 111 determines that the electronic key 2 is not outside the vehicle (step S11: NO), the entry/exit support control unit 114 determines whether or not the driver's seat door 7 has been changed from the open state to the closed state (step S21). If the driver's seat door 7 has not been changed from the open state to the closed state (step S21: NO), the entry/exit support control unit 114 repeats the determination of step S21.

For example, in a case when a user other than the driver remains in the vehicle, the driver may exit the vehicle without the electronic key 2.

Next, entry/exit support control unit 114 determines, using the brake sensor 93, whether or not the brake pedal 11 has been depressed (step S22), and repeats the determination of step S22 if the brake pedal 11 has not been depressed (step S22: NO).

If the brake pedal 11 has been depressed (step S22: YES), the entry/exit support control unit 114 operates the seat drive unit 94 and the column drive unit 95 to control the driver's seat 5 and the steering column 4 in the driver's seat area 3 to have the returned positional relationship (step S23). The second power source control mode is reset, and then the process is performed as if the first power source control mode is selected.

Thus, in the second power source control mode, when the brake pedal 11 is operated in a situation in which the electronic key 2 is located inside the vehicle 1, the entry/exit support control unit 114 controls the positional relationship between the driver's seat 5 and the steering column 4 in the driver's seat area 3 to be the returned positional relationship.

Returning to the explanation of step S2, if the second power source control mode is not selected (step S2: NO), the power source control unit 112 goes into the first power source control mode. Next, the entry/exit support control unit 114 determines whether or not the driver's seat door 7 has been changed from the closed state to the open state (step S31). If the driver's seat door 7 has not been changed from the closed state to the open state (step S31: NO), the entry/exit support control unit 114 repeats the determination of step S31. If the driver's seat door 7 has been changed from the closed state to the open state (step S31: YES), the entry/exit support control unit 114 operates the seat drive unit 94 and the column drive unit 95 to control the driver's seat 5 and the steering column 4 in the driver's seat area 3 to have the retracted positional relationship (step S32).

Next, the entry/exit recognition unit 111 determines whether or not the electronic key 2 is outside the vehicle (step S33). If the entry/exit recognition unit 111 determines that the electronic key 2 is inside the vehicle (step S33: NO), the process proceeds to step S22.

If the entry/exit recognition unit 111 determines that the electronic key 2 is outside the vehicle (step S33: YES), the power source control unit 112 recognizes that the driver's seat door 7 has been changed to the closed state by the user (step S34), and the power source control unit 112 switches the supply from the driving power source 130 to the off state (step S35).

Next, the entry/exit recognition unit 111 determines whether or not the driver has entered the vehicle by determining whether or not the electronic key 2 is outside the vehicle (step S36), and repeats the determination of step S36 if the driver has not entered the vehicle (step S36: NO).

If the entry/exit recognition unit 111 determines that the driver has entered the vehicle (step S36: YES), the power source control unit 112 switches the supply from the driving power source 130 to the on state (step S37).

Next, the switching of the supply from the driving power source 130 to the on state triggers the entry/exit support control unit 114 to operate the seat drive unit 94 and the column drive unit 95, and control the driver's seat 5 and the steering column 4 in the driver's seat area 3 to have the returned positional relationship (step S38).

Note that the vehicle 1 may have an accessory power source switch, and switching of the accessory power source switch from an off state to an on state may be used as a trigger to execute step S38. Moreover, when the electronic key 2 is present in the vehicle, the depression of the brake pedal 11 may be used as a trigger to cause the power source control unit 112 to switch the supply from the driving power source 130 to the on state, and execute step S38.

Thus, in the first power source control mode, after switching the supply from the driving power to the off state in response to satisfying the exit completion determination condition, when the entry/exit recognition unit 111 recognizes that the user has entered the vehicle, the power source control unit 112 switches the supply from the driving power source 130 to the on state. Further, in the first power source control mode, after the power source control unit 112 switches the supply from the driving power source 130 to the off state in response to satisfying the exit completion determination condition, when the user operates the power source switch 92 or operates the brake pedal 11, the entry/exit support control unit 114 controls the positional relationship between the driver's seat 5 and the steering column 4 in the driver's seat area 3 to be the returned positional relationship.

### Other Embodiments

The control device 100 may be configured to be able to customize the operation speeds of the seat drive unit 94 and the column drive unit 95 when the positional relationship changes between the returned positional relationship and the retracted positional relationship.

The control device 100 may be configured to automatically change a window provided in the driver's seat door 7 or another door to a closed state when the user exits the vehicle.

The control device 100 is configured to switch between the returned positional relationship and the retracted positional relationship, based on the predetermined condition, but may also be configured to allow the user to make a setting to disable switching between the returned positional relationship and the retracted positional relationship.

The control device 100 is configured to switch between the returned positional relationship and the retracted positional relationship, based on the predetermined condition, but may also be configured to be able to cancel the switching operation between the returned positional relationship and the retracted positional relationship by operating a predetermined operator (for example, a seat manual switch or a seat position switch) partway through.

The processor 110 may be constituted by a single processor, or may be constituted by a plurality of processors. These processors may be hardware programmed to realize the corresponding functional units. Namely, these processors may be configured, for example, by an application specific integrated circuit (ASIC) and a field programmable gate array (FPGA).

The configuration of the vehicle 1 shown in FIG. 2 is an example, and specific implementation forms are not particularly limited. In other words, it is not necessary to individually implement hardware corresponding to each unit, and it is possible to achieve a configuration that realizes the functions of the respective units by causing one processor to execute a program. Moreover, in the above-described embodiments, some of the functions realized by software may be realized by hardware, or some of the functions realized by hardware may be realized by software.

In order to make it easier to understand the operation, an operation step unit illustrated in FIG. 3 is defined by dividing the operation according to the major processing contents, and therefore the operation is not limited by how the process is divided into process units, or the names of the process units. Further, the process may be divided into more step units according to process contents. Moreover, each step unit may be divided to include more process steps. Furthermore, the order of the steps may be suitably changed within a range not hindering the objective of the present disclosure.

Note that the above-described embodiments are intended to indicate examples of the technology of the present disclosure, and various modifications, substitutions, additions, omissions, etc. can be made within the scope of the claims or equivalents thereof.

The above-described embodiments are specific examples of the following configurations.
(Configuration 1) A vehicle control device for controlling activation of a vehicle having a driver's seat area drive unit that changes a positional relationship between a steering column and a driver's seat in a driver's seat area, and a driver's seat door sensor that detects open and closed states of a driver's seat door, the vehicle control device including: an entry/exit recognition unit that recognizes that a user of the vehicle has entered or exited the vehicle; a power source control unit that switches between a first power source control mode and a second power source control mode, wherein, in the first power source control mode, the power source control unit switches supply from a driving power source of the vehicle to an off state in response to a selection operation of the user when an exit completion determination condition in which the entry/exit recognition unit recognizes that user has exited the vehicle and the driver's seat door sensor detects that the driver's seat door has been changed from an open state to a closed state is satisfied, and, in the second power source control mode, the power source control unit keeps the supply from the driving power source in an on state even after the exit completion determination condition is satisfied; and an entry/exit support control unit that causes the driver's seat area drive unit to switch the positional relationship between the steering column and the driver's seat in the driver's seat area, between a first positional relationship suitable for driving and a second positional relationship suitable for entering and exiting the vehicle, wherein, when the driver's seat door sensor detects that the driver's seat door has been changed from the closed state to the open state while the vehicle is in a parked state, the entry/exit support control unit changes the positional relationship to the second positional relationship by moving at least one of the steering column and the driver's seat in the driver's seat area, and, in the second power source control mode, after the entry/exit recognition unit recognizes that the user has exited the vehicle, when the driver's seat door sensor detects two or more times that the driver's seat door has been changed from the open state to the closed state and it is recognized that the user is in the vehicle, the entry/exit support control unit controls the positional relationship between the steering column and the driver's seat in the driver's seat area to be the first positional relationship.

According to configuration 1, when a driver, who has exited the vehicle with the driving power source of the vehicle being kept in the on state, returns and enters the vehicle, the positional relationship between the steering column and the driver seat is automatically returned to the positional relationship suitable for driving, without depending on the driver to operate an operator, thereby improving the ease of entry and exit.
(Configuration 2) The vehicle control device according to configuration 1, wherein, in the first power source control mode, after switching the supply from the driving power source to the off state in response to satisfying the exit completion determination condition, when the entry/exit recognition unit recognizes that the user has entered the vehicle, the power source control unit switches the supply from the driving power source to the on state.

According to configuration 2, when the second power source control mode is not selected and the first power source control mode is selected, the driving power source is switched to the off state when the user exits the vehicle, and the driving power source is switched to the on state when the user enters the vehicle. Therefore, it is not necessary for the user to switch the driving power source between on and off each time the user enters or exits the vehicle, thereby improving convenience.
(Configuration 3) The vehicle control device according to configuration 1 or 2, wherein, when the supply from the driving power source is changed from the off state to the on state, or when the user operates a brake pedal provided in the vehicle while the supply from the driving power source is in the on state, the entry/exit support control unit controls the positional relationship between the steering column and the driver's seat in the driver's seat area to be the first positional relationship.

According to configuration 3, when the user operates a power source switch provided in the vehicle, or when the user operates the brake pedal provided in the vehicle, the positional relationship between the steering column and the driver's seat is changed to the first positional relationship. Therefore, when the supply from the driving power source is automatically switched to the on state when the user enters the vehicle, or, even when the user enters the vehicle from other than the driver's seat and moves to the driver's seat, the positional relationship can be automatically changed to the first positional relationship, thereby improving the ease of entry and exit.
(Configuration 4) The vehicle control device according to any one of configurations 1 to 3, wherein the entry/exit recognition unit recognizes that the user has entered the vehicle or exited the vehicle by recognizing, based on the communication status between a communication device provided in the vehicle and an electronic key used by the user, whether the electronic key is located outside or inside the vehicle.

According to configuration 4, since whether the user has entered the vehicle is determined by the presence of the electronic key inside the vehicle, and whether the user has exited the vehicle is determined by the absence of the electronic key inside the vehicle, the detection of the user can be performed without adding detection means such as a seat sensor.

### REFERENCE SIGNS LIST

1 . . . vehicle; 2 . . . electronic key; 3 . . . driver's seat area; 4 . . . steering column; 5 . . . driver's seat; 7 . . . driver's seat door; 11 . . . brake pedal; 91 . . . communication device; 92 . . . power source switch; 93 . . . brake sensor; 94 . . . seat drive unit (driver's seat area drive unit); 95 . . . column drive unit (driver's seat area drive unit); 96 . . . driver's seat door sensor; 100 . . . control device (vehicle control device); 110 . . . processor; 111 . . . entry/exit recognition unit; 112 . . . entry/exit support control unit; 114 . . . entry/exit support control unit; 120 . . . memory; 121 . . . program; 122 . . . count data; and 130 . . . driving power source.

1. A vehicle control device for controlling activation of a vehicle having a driver's seat area drive unit that changes a positional relationship between a steering column and a driver's seat in a driver's seat area, and a driver's seat door sensor that detects open and closed states of a driver's seat door, the vehicle control device comprising:
an entry/exit recognition unit that recognizes that a user of the vehicle has entered or exited the vehicle;
a power source control unit that switches between a first power source control mode and a second power source control mode, wherein, in the first power source control mode, the power source control unit switches supply from a driving power source of the vehicle to an off state in response to a selection operation of the user when an exit completion determination condition in which the entry/exit recognition unit recognizes that user has exited the vehicle and the driver's seat door sensor detects that the driver's seat door has been changed from an open state to a closed state is satisfied, and, in the second power source control mode, the power source control unit keeps the supply from the driving power source in an on state even after the exit completion determination condition is satisfied; and
an entry/exit support control unit that causes the driver's seat area drive unit to switch the positional relationship between the steering column and the driver's seat in the driver's seat area, between a first positional relationship suitable for driving and a second positional relationship suitable for entering and exiting the vehicle, wherein,
when the driver's seat door sensor detects that the driver's seat door has been changed from the closed state to the open state while the vehicle is in a parked state, the entry/exit support control unit changes the positional relationship to the second positional relationship by moving at least one of the steering column and the driver's seat in the driver's seat area, and,
in the second power source control mode, after the entry/exit recognition unit recognizes that the user has exited the vehicle, when the driver's seat door sensor detects two or more times that the driver's seat door has been changed from the open state to the closed state and it is recognized that the user is in the vehicle, the entry/exit support control unit controls the positional relationship between the steering column and the driver's seat in the driver's seat area to be the first positional relationship.

2. The vehicle control device according to claim 1, wherein, in the first power source control mode, after switching the supply from the driving power source to the off state in response to satisfying the exit completion determination condition, when the entry/exit recognition unit recognizes that the user has entered the vehicle, the power source control unit switches the supply from the driving power source to the on state.

3. The vehicle control device according to claim 1, wherein, when the supply from the driving power source is changed from the off state to the on state, or when the user operates a brake pedal provided in the vehicle while the supply from the driving power source is in the on state, the entry/exit support control unit controls the positional relationship between the steering column and the driver's seat in the driver's seat area to be the first positional relationship.

4. The vehicle control device according to claim 1, wherein the entry/exit recognition unit recognizes that the user has entered the vehicle or exited the vehicle by recognizing, based on a communication status between a communication unit provided in the vehicle and an electronic key of the vehicle used by the user, whether the electronic key is located outside or inside the vehicle.
